(19) United States
(12) Patent Application Publication
(10) Pub. No.: US 2017/0180436 A1
(43) Pub. Date: Jun. 22, 2017

(54) Upload of Multimedia Content

(71) Applicant: Telefonaktiebolaget LM Ericsson (publ), Stockholm (SE)

(72) Inventors: Jacob Ström, Stockholm (SE); Tommy Arngren, Södra Sunderbyn (SE)

(73) Assignee: Telefonaktiebolaget LM Ericsson (publ), Stockholm (SE)

(21) Appl. No.: 15/315,788

(22) PCT Filed: May 22, 2015
(86) PCT No.: PCT/SE2015/050594

§ 371 Date: Dec. 2, 2016

Related U.S. Application Data
(60) Provisional application No. 62/008,108, filed on Jun. 5, 2014.

(51) Int. Cl. H04L 29/06; H04N 21/2743

(52) U.S. Cl. CPC H04L 65/4076; H04N 21/2743; H04L 65/1063; H04N 21/4788

(57) ABSTRACT

A full multimedia content is broadcasted or multicasted to end users from a network node (2; 2A). The end users select a respective multimedia content from the full multimedia content and send a respective index associated with the respective selected multimedia content to a network node (2; 2B) to trigger uploading of the respective selected multimedia content or a version thereof on a social networking server (4) on behalf of the end users. The embodiments thereby end users to upload multimedia content on their accounts at social networking servers (4) also in situations with limited uplink capacity by merely sending indices associated with the multimedia content instead of the actual multimedia content itself.

### TECHNICAL FIELD

The present embodiments generally relate to upload of multimedia content to social networking servers, and in particular to upload solutions that are efficient also in limited upload capacity situations.

### BACKGROUND

Social networks, such as Facebook and Instagram, are part of the daily life for over a billion people worldwide. Some people even feel that they have not fully experienced an event in life until they have posted an image or a status update about the experience on a social network, may it be a wedding or a daily meal.

Currently content, such as images and videos, is uploaded from the users' smart phone or tablet via a communication network, such as a local area wireless network (WiFi) or a cellular network, to the social networking servers of the social media providers, for instance Instagram.

The traditional way of posting images and videos works fine most of the time when there is sufficient uplink capacity in the communication network. However, in some situations such uplink capacity may be scarce and limited. For instance, in an arena setting, such as at a pop concert or a football game, sufficient cellular or WiFi uplink capacity may not be available. The reason is that the communication network may be congested especially when almost every user wants to do the same thing, such as uploading a picture after a goal in a soccer game. Such network congestion makes uploads impossible or at least significantly delays the uploading of taken pictures.

Thus, there is a need for an efficient solution that enables the uploading of pictures and other multimedia contents to social networking servers, for instance Facebook and Instagram. It is a particular need for an efficient solution that works also in places and situations where and when a large number of users want to perform such multimedia content uploads.

### SUMMARY

It is a particular objective to provide an efficient solution for the uploading of multimedia content to social networking servers.

This and other objectives are met by embodiments described herein.

An aspect of the embodiments relates to a method for a communication device of an end user for uploading a multimedia content to a social networking server. The method comprises receiving a full multimedia content broadcasted or multicasted from a network node. The method also comprises selecting a multimedia content from the full multimedia content. The method further comprises sending an index associated with the selected multimedia content to a network node to trigger uploading of the selected multimedia content or of a version of the selected multimedia content on the social networking server on behalf of the end user.

A related aspect of the embodiments defines a communication device configured to send, to a network node, an index associated with a multimedia content selected from a full multimedia content broadcasted or multicasted from a network node to trigger uploading of the selected multimedia content or of a version of the selected multimedia content on a social networking server on behalf of an end user of the communication device.

Another related aspect of the embodiments defines a communication device comprising a sender for sending, to a network node, an index associated with a multimedia content selected from a full multimedia content broadcasted or multicasted from a network node to trigger uploading of the selected multimedia content or of a version of the selected multimedia content on a social networking server on behalf of an end user of the communication device.

Another aspect of the embodiments relates to a method for a network node arrangement for uploading a multimedia content to a social networking server. The method comprises receiving a full multimedia content from a venue server. The full multimedia content resides on the venue server. The method also comprises broadcasting or multicasting the full multimedia content to a communication device of an end user. The method further comprises receiving, from the communication device, an index associated with a multimedia content selected from the full multimedia content. The method additionally comprises sending the received index to trigger uploading of the selected multimedia content or of a version of the selected multimedia content on the social networking server on behalf of the end user.

A related aspect of the embodiments defines a network node arrangement. The network node arrangement is configured to broadcast or multicast a full multimedia content received from a venue server housing the full multimedia content. The network node arrangement is also configured to send an index associated with a multimedia content selected by an end user from the full multimedia content to trigger uploading of the selected multimedia content or of a version of the selected multimedia content on a social networking server on behalf of the end user.

A further aspect of the embodiments relates to a method for a venue server for uploading a multimedia content to a social networking server. The method comprises sending a full multimedia content residing on the venue server to a network node. The method also comprises receiving an index associated with a multimedia content selected by an end user from the full multimedia content. The method further comprises selecting a multimedia content that corresponds to the received index from the full multimedia content. The method additionally comprises sending the selected multimedia content or a version of the selected multimedia content to the social networking server to trigger uploading of the selected multimedia content or of the version of the selected multimedia content on the social networking server on behalf of the end user.

A related aspect of the embodiments defines a venue server configured to send, to a social networking server, a multimedia content selected based on a received index associated with a multimedia content selected by an end user from a full multimedia content residing on the venue server to trigger uploading of the selected multimedia content or of a version of the selected multimedia content on the social networking server on behalf of the end user.

Another related aspect of the embodiments defines a venue server comprising a sender for sending, to a social networking server, a multimedia content selected based on a received index associated with a multimedia content selected by an end user from a full multimedia content residing on the venue server to trigger uploading of the selected multimedia content or of a version of the selected multimedia content on the social networking server on behalf of the end user.

Yet another aspect of the embodiments relates to a method for a social networking server for uploading a multimedia content. The method comprises receiving an index associated with a multimedia content selected by an end user from a full multimedia content residing on a venue server. The method also comprises sending the index to the venue server. The method further comprises receiving the selected multimedia content or a version of the selected multimedia content from the venue server. The method additionally comprises uploading the selected multimedia content or the version of the selected multimedia content on behalf of the end user.

A related aspect of the embodiments defines a social networking server configured to send, to a venue server, an index associated with a multimedia content selected by an end user from a full multimedia content residing on the venue server. The social networking server is also configured to upload, on behalf of the end user, the selected multimedia content or a version of the selected multimedia content received from the venue server.

Yet another aspect of the embodiments relates to a computer program comprising instructions, which when executed by a processor, cause the processor to provide for transmission, to a network node, of an index associated with a multimedia content selected by an end user from a full multimedia content broadcasted or multicasted from a network node to trigger uploading of the selected multimedia content or of a version of the selected multimedia content on a social networking server on behalf of the end user.

A further aspect of the embodiments relates to a computer program comprising instructions, which when executed by a processor, cause the processor to output for broadcast or multicast of a full multimedia content received from a venue server housing the full multimedia content. The processor is also caused to send an index associated with a multimedia content selected by an end user from the full multimedia content to trigger uploading of the selected multimedia content or of a version of the selected multimedia content on a social networking server on behalf of the end user.

An additional aspect of the embodiments relates to a computer program comprising instructions, which when executed by a processor, cause the processor to provide for transmission, to a social networking server, of a multimedia content selected based on a received index associated with a multimedia content selected by an end user from a full multimedia content residing on a venue server to trigger uploading of the selected multimedia content or of a version of the selected multimedia content on the social networking server on behalf of the end user.

A further aspect of the embodiments relates to a computer program comprising instructions, which when executed by a processor, cause the processor to provide for transmission, to a venue server, of an index associated with a multimedia content selected by an end user from a full multimedia content residing on the venue server. The processor is also caused to upload, on behalf of the end user, the selected multimedia content or a version of the selected multimedia content received from the venue server.

A related aspect of the embodiments defines a carrier comprising a computer program according to above. The carrier is one of an electronic signal, an optical signal, an electromagnetic signal, a magnetic signal, an electric signal, a radio signal, a microwave signal, or a computer-readable storage medium.

The present embodiments provide an efficient upload solution that enables end users to upload multimedia content on social networking servers also in limited upload capacity situations.

### BRIEF DESCRIPTION OF THE DRAWINGS

The embodiments, together with further objects and advantages thereof, may best be understood by making reference to the following description taken together with the accompanying drawings, in which:

FIG. 1 describes the traditional approach where the end user takes a photograph with his mobile telephone and uploads it over a mobile network, e.g. 3G/4G, to social networking servers, e.g. Instagram;

FIG. 2 illustrates an approach according to an embodiment of uploading a photograph on a social networking server on behalf of an end user;

FIG. 3 illustrates another approach according to an embodiment of uploading a photograph on a social networking server on behalf of an end user;

FIG. 4 illustrates a further approach according to an embodiment of uploading a photograph on a social networking server on behalf of an end user;

FIG. 5 is a flow chart of a method for a communication device of an end user according to an embodiment;

FIG. 6 is a flow chart of an additional, optional step of the method shown in FIG. 5 according to an embodiment;

FIG. 7 is a flow chart of a method for a network node arrangement according to an embodiment;

FIG. 8 is a flow chart of a method for a venue or cloud server according to an embodiment;

FIG. 9 is a flow chart of an additional, optional step of the method shown in FIG. 8 according to an embodiment;

FIG. 10 is a flow chart of an additional, optional step of the method shown in FIG. 8 according to an embodiment;

FIG. 11 is a flow chart of a method for a social networking server according to an embodiment;

FIG. 12 is a flow chart of a method for a social networking server according to another embodiment;

FIG. 13 illustrates a communication device of an end user according to an embodiment;

FIG. 14 illustrates a communication device of an end user according to another embodiment;

FIG. 15 illustrates a communication device of an end user according to a further embodiment;

FIG. 16 illustrates a network node according to an embodiment;

FIG. 17 illustrates a network node according to another embodiment;

FIG. 18 illustrates a venue or cloud server according to an embodiment;

FIG. 19 illustrates a venue or cloud server according to another embodiment;

FIG. 20 illustrates a venue or cloud server according to a further embodiment;

FIG. 21 illustrates a social networking server according to an embodiment;

FIG. 22 illustrates a social networking server according to another embodiment;

FIG. 23 illustrates a social networking server according to a further embodiment; and

FIG. 24 schematically illustrates a computer program implementation of embodiments.

### DETAILED DESCRIPTION

Throughout the drawings, the same reference numbers are used for similar or corresponding elements.

The present embodiments generally relate to upload of multimedia content to social networking servers, and in particular to upload solutions that are efficient also in limited upload capacity situations.

FIG. 1 describes the traditional approach, where the end user takes a photograph with his/her communication device 1, such as mobile or smart phone, and uploads it over 3G/4G to Instagram's servers 4. In this traditional approach, the multimedia content, here represented by a photograph, is uploaded over a mobile or cellular communication network to a network node 2, generally referred to as base station, Node-B or evolved Node-B (eNode-B) in the art, and forwarded to a social networking server 4, such as an Instagram server. This procedure generally works well under most conditions. However, in situations where a large number of end users are present within the same geographical area and several of them tries to upload multimedia content to social networking servers 4, there might not be sufficient uplink capacity to serve all end users and the communication network will be congested. A typical situation where this might happen is in an arena setting, such as at music or sports events. In such a case, several thousands or even several tens of thousands of end users could be present in the arena and would like to upload photographs or video clips taken with their mobile or smart phones 1 during the music or sports event. This high amount of uplink traffic, i.e. from the communication devices 1 to network nodes 2, will deplete the uplink capacity of the communication network causing congestion. As a consequence, several end users will experience long delays in uploading their multimedia content on the social networking server 4 or such uploading might be impossible due to the congestion.

The present embodiments solve such prior art problems by broadcasting or multicasting multimedia content to the communication devices 1 of the end users. The end users can then select a received multimedia content that he/she would like to upload on his/her account at the social networking server 4. Information of the selected multimedia content, such as in the form of an index or identifier, is then uploaded, i.e. sent towards the network node 2 of the communication network, to trigger, i.e. cause or enable, uploading of the selected multimedia content on or at the social networking server 4 on behalf of the end user. This means that only the index or identifier of the selected multimedia content needs to be uploaded and not the actual multimedia content itself. For instance, a 2048×2048 picture uploaded onto a social networking server 4 could be about 1 Mb. If the end user instead receives a video that runs continuously from the start of, for instance, a 1 hour concert to the end of the concert with 60 frames per second (fps), then the video contains a total of 216,000 frames or pictures. The end user can then select to upload one of these frames using an index of four bytes since 216,000<2³² implying that it is sufficient with one integer, which is four bytes. Thus, in this example the amount of data sent on the uplink by the end user is reduced from about 1 Mb down to four bytes in order to upload a selected picture on the social networking server 4. This significantly reduces the amount of data that the communication device 1 needs to transmit on the uplink to the network node 2 when uploading a multimedia content on the social networking server 4 as compared to the prior art situation where the actual multimedia content needs to be uploaded.

Accordingly, the risk of depleting uplink capacity and causing network congestion are significantly reduced according to the embodiments.

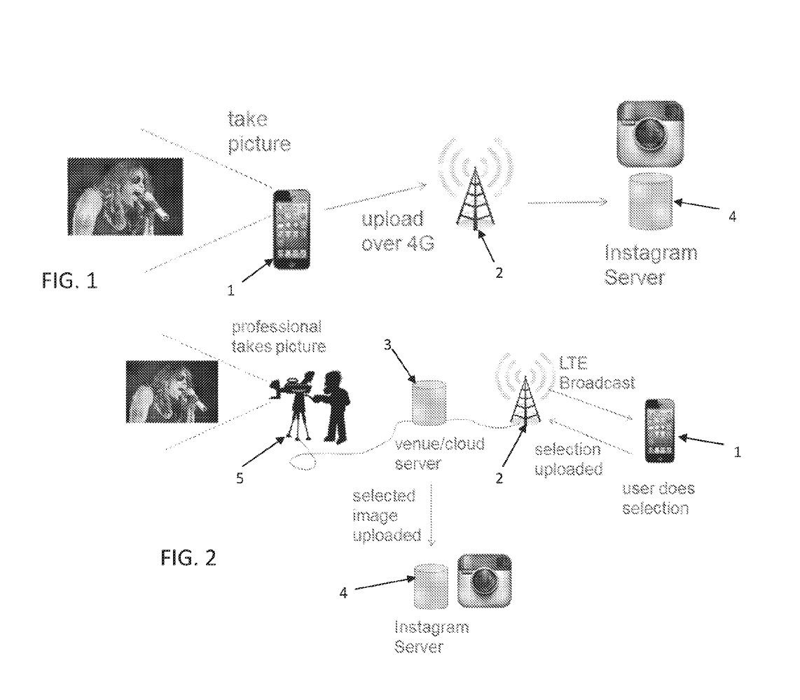

FIG. 2 describes an embodiment of the proposed invention. The multimedia content, such as photos, video, etc., is taken by a professional 5. Further on, each multimedia content, such as taken photo, is given an identifier (ID) or index to which an end user can refer to in case of selecting it. In case of a video, an ID or index can be a frame number. The multimedia content is subsequently downloaded to the communication device 1, such as mobile phone, of the end user using broadcast or multicast, e.g. long term evolution (LTE) broadcast or multicast. The end user then makes a selection of the multimedia content that will be uploaded on his/her behalf on a social networking server 4. The ID or index associated with the selected multimedia content is uploaded via a mobile network and a network node 2 to a venue server 3, which could be in the form of a cloud server. The venue/cloud server 3 then uploads the multimedia content, such as photo, associated with the received ID or index to the social networking server 4.

Multimedia Broadcast Multicast Service (MBMS) is a point-to-multipoint interface specification for mobile or cellular networks to provide efficient delivery of broadcast and multicast services both within a cell as well as within the core network. For broadcast or multicast transmission across multiple cells, MBMS defines transmission via single-frequency network configurations denoted multicast-broadcast single-frequency network (MBSFN). MBSFN is a communication channel defined in LTE. Enhanced or evolved MBMS (eMBMS) is the LTE version of MBMS and delivers services, such as mobile TV, using the LTE infrastructure. In eMBMS each TV program is only transmitted once in each cell even if there are several viewers of that program in the same cell. MBSFN is based on the principles of dynamic single frequency networks (DSFN), in which single-frequency networks (SFNs) are dynamically formed when groups of adjacent network nodes, e.g. eNode-Bs, send the same signal simultaneously on the same frequency sub-carriers. In effect, this makes the MBSFN transmission appear to an end user as a transmission from a single large cell, thereby dramatically increasing the signal-to-interference ratio (SIR).

Accordingly, eMBMS provides transport features for broadcasting the same content to all end users in a cell or multicasting the same content to a given set of end users in a cell using a subset of the available radio resources while the remaining radio resources are available to support of unicast services.

The transmission of the multimedia content to the communication devices 1 of the end users in order to enable the end users to select a multimedia content to be uploaded on the social networking server 4 on behalf of the end user is preferably performed as a broadcast or multicast transmission, such as over a MBSFN channel from the network node 2. This means that the multimedia content is preferably sent as an eMBMS transmission, i.e. broadcast or multicast, from the network node 2 to the communication devices 1, such as in the form of a LTE broadcast or multicast.

Although LTE broadcast or multicast are preferred examples of broadcast or multicast solutions to transmit the multimedia content to multiple, i.e. at least two, communication devices 1 in a given area, such as at an arena, the embodiments are not limited thereto. Actually, any broadcast or multicast solution that is capable of transmitting multimedia content to multiple communication devices 1 as disclosed herein can be used according to the embodiments.

In the case of a broadcast transmission, such as LTE broadcast, the same multimedia content is transmitted to all communication devices 1 that are present within the coverage area(s) of the network node(s) 2 performing the broadcast. Note that LTE broadcast can be performed by a single network node 2 or by multiple adjacent network nodes 2. In the latter case, these network nodes send the same signal simultaneously on the same frequency sub-carriers. In effect, this makes the broadcast transmission appear to a communication device 1 as a transmission from a single large cell.

It is also possible to perform the transmission of the multimedia content to multiple communication devices 1 in the form of a multicast, such as LTE multicast. In such a case, the same multimedia content is transmitted to a group of communication devices 1 but not necessarily to all communication devices 1 that are present within the coverage area(s) of the network node(s) 2 performing the multicast. For instance, multicast could be directed towards communication devices 1 of end users having a subscription enabling them to receive multimedia content taken during, for instance, a music or sports event. The end users could, for instance, have bought a special or “gold” ticket to the music or sports event.

In the following, “full multimedia content” is used to denote the set or group of multimedia contents broadcast or multicast to communication devices 1 from one or more network nodes 2. “Full” as used herein indicates that the broadcasted or multicasted multimedia content comprises multiple individual media contents that the end user could select among. For instance, the full multimedia content could be in the form of multiple pictures taken or generated by a multimedia generating or capturing equipment 5, typically a camera. In such a case, the end user can select one of these pictures. Another example of a full multimedia content is a video stream or sequence. In such a case, the end user can select a picture or frame, i.e. a snap-shot, within the video sequence or stream or indeed select a sub-stream or sub-sequence of the video stream or sequence. Yet another example of a full multimedia content is an audio sequence or stream, in which case the end user can select a sub-stream or sub-sequence of the audio stream or sequence, i.e. a portion of the audio stream of sequence, e.g. a clip of Xs out of the Ys of the audio stream or sequence, wherein X<Y.

The social networking server 4 could be any server at which end users can upload multimedia content, such as pictures, video and/or audio. Non-limiting, but illustrative, examples include Facebook, Instagram, Vimeo, YouTube, Twitter, Flickr, Google+, Pinterest, Reddit, Vine, etc. The end user then preferably has an account or subscription at the social networking service provider to allow the end user to upload multimedia content on his/her account at the social networking server 4.

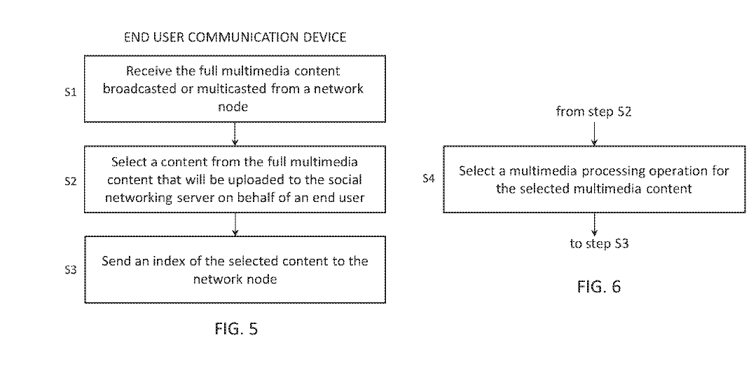

FIG. 5 is a flow chart illustrating a method for a communication device of an end user for uploading a multimedia content to a social networking server according to an embodiment. The method comprises receiving, in step S1, a full multimedia content broadcasted or multicasted from a network node. The method also comprises selecting, in step S2, a multimedia content from the full multimedia content. The method further comprises sending, in step S3, an index associated with the selected multimedia content to a network node to trigger uploading of the selected multimedia content or of a version of the selected multimedia content on the social networking server on behalf of the end user.

With reference to FIGS. 2-4, multimedia content generated by at least one multimedia generating or capturing equipment 5, such as at least one camera, at least one video camera, or at least one audio recorder, is provided to a venue server 3, where the full multimedia content is residing. The full multimedia content is provided to a network node arrangement of one or multiple network nodes 2, 2A, 2B, which broadcasts or multicasts the full multimedia content to receiving communication devices 1. Each end user can then select a multimedia content from or among the full multimedia content. An index or identifier associated with the selected multimedia content, i.e. identifies the selected multimedia content, is then uploaded from the communication device 1 to a network node 2, 2B of the network node arrangement. This index could for instance be transmitted in the form of a message or command comprising the index.

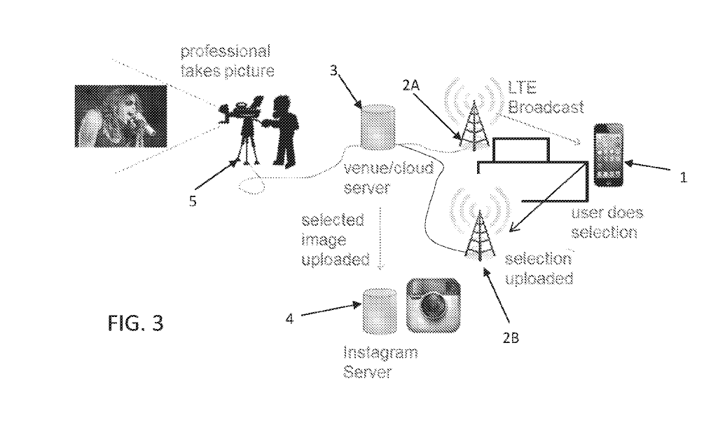

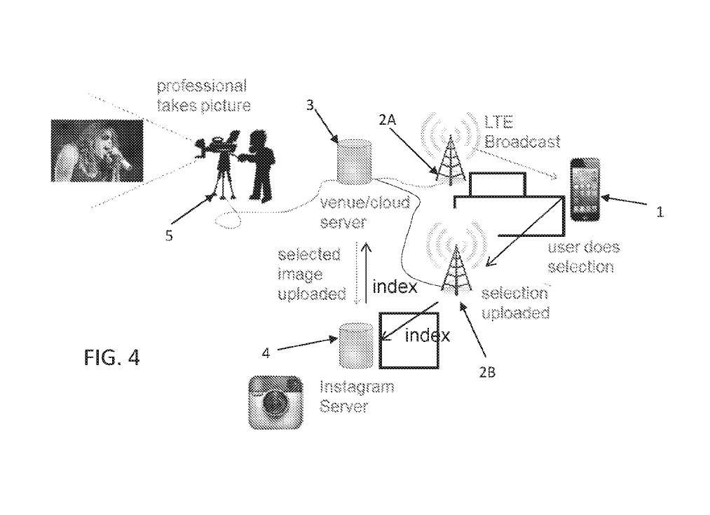

In FIG. 2 the index is transmitted from the communication device 1 to the same network node 2 that conducted the broadcast or multicast of the full multimedia content. FIGS. 3 and 4 illustrate another situation, in which the network node 2B that receives the index from the communication device 1 may be different from the network node 2A broadcasted or multicasted the full multimedia content.

In FIGS. 2 and 3, the network node 2, 2B receiving the index forwards it to the venue server 3. In FIG. 4, the network node 2B instead forwards it to the social networking server 4, which in turn sends the index to the venue server 3. The venue server 3 can then use the received index in order to identify and select the multimedia content associated with the index and selected by the end user. The venue server 3 transmits the selected multimedia content to the social networking server 4, where it is uploaded on behalf of the end user.

This means that the end user is able to upload multimedia content on his/her account at the social networking server 4 without the need for any transmission of the actual multimedia content on the uplink from the communication device 1 to a network node 2, 2B within the communication network. In clear contrast, the communication device 1 merely needs to transmit the index on the uplink in order to trigger, cause or enable upload of the selected multimedia content or of a version of the selected multimedia content on the social networking server 4 on behalf of the end user.

The actual multimedia content that is uploaded on the social networking server 4 could be the multimedia content selected by the end user or a version thereof. Examples of the latter are further described herein but could include a processed version of the selected multimedia content, such as a filtered or modified version of a picture, or a version at another quality than the one broadcast or multicast by the network node 2, 2A and selected by the end user.

The index sent by the communication device 1 in step S3 of FIG. 5 could be sent as any index or identifier associated with the selected multimedia content. In the case of a set of pictures, the index could be a picture number of the selected picture within the set of pictures. Another example of index is a frame or picture number, e.g. picture order count (POC) value, of a selected frame or picture within a video stream. A further example include an index in the form of a range of frame/picture or sample values, such as defining a video or audio sub-stream from frame/picture or audio sample number Z₁ to frame/picture or audio sample number Z₂ within a video or audio stream. A related example is to have an index defining the video or audio sub-stream as corresponding to from W₁ s to W₂ s from the start of the video or audio stream. This means that the index may comprise more than a single data entity, such as frame or picture number, including a start frame or picture number or start audio sample number and an end frame or picture number or end audio sample number.

In an embodiment, the communication device 1 sends a command with the index. This command could then be a message, such as of a defined message type, instructing the venue server 3 to identify a multimedia content from the full multimedia content residing on or at the venue server 3 and forward the multimedia content to the social networking server 4 where it is uploaded on behalf of the end user (see FIGS. 2 and 3). Alternatively, the command could trigger the social networking server 4 to request the selected multimedia content from the venue server 3 and then upload it on behalf of the end user (see FIG. 4).

In an embodiment, step S3 of FIG. 5 comprises sending the index and an identifier of the end user at the social networking server 4 to the network node 2, 2B to trigger uploading of the selected multimedia content or of the version of the selected multimedia content on the social networking server 4 on behalf of the end user identified by the identifier.

Hence, in this case the communication device 1 preferably sends a command or message comprising not only the index but also an identifier of the end user at the social networking server 4. This identifier could be any information that enables the social networking server 4 to identify the particular account for which it should upload the selected multimedia content (version) received or requested from the venue server 3. The identifier could be present in a header or in a payload portion of the command or message comprising the index and that is compiled and sent by the communication device 1.

In an embodiment, step S1 comprises receiving the full multimedia content over a multicast-broadcast single frequency network (MBSFN) channel from the network node 2, 2A. Thus, in an embodiment step S1 comprises receiving the full multimedia content as an evolved multimedia broadcast multicast service (eMBMS) transmission, or broadcast or multicast from the network node 2, 2A. This corresponds to receiving the full multimedia content in step S1 as a long term evolution (LTE) broadcast or multicast from the network node 2, 2A.

LTE broadcast or multicast, i.e. eMBMS transmission, using a MBSFN channel is an efficient way of sending content to all or selected portion of communication devices 1 within the coverage area of a network node 2, 2A or an arrangement of network nodes 2, 2A. As a consequence, only a subset of the available downlink radio resources need to be used to provide the full multimedia content to the communication devices 1, thereby leaving remaining downlink radio resources available to support, for instance, unicast services.

In an embodiment, the communication device 1 comprises a social networking application running or implemented on the communication device 1, for instance a Facebook or Instagram application (app). In such a case, step S1 of FIG. 5 preferably comprises downloading or streaming, using a broadcast or multicast transmission from the network node 2, 2A, the full multimedia content to the social networking application running on the communication device 1.

In this embodiment, the end user is able to receive and view the full multimedia content on the social networking application implemented in and running on his/her communication device 1. For instance, the social networking application may trigger display of a message on the screen of the communication device 1 once the social networking application has received or is currently receiving the full multimedia content broadcasted or multicasted from the network node 2, 2A. The end user may then view the full multimedia content on the screen in order to select a multimedia content from the full multimedia content. In such a case, the social networking application preferably generates and sends the index associated with the selected multimedia content to the network node 2, 2B to trigger uploading of the selected multimedia content or of the version of the selected multimedia content on the social networking server 4 on behalf of the end user.

FIG. 6 is a flow chart illustrating an additional, optional step of the method shown in FIG. 5. The method continues from step S2. A next step S4 comprises selecting a multimedia processing operation for the selected multimedia content. The method then continues to step S3 in FIG. 5, which comprises sending the index and at least one of a processing command and a parameter defining the selected multimedia processing operation to the network node 2, 2B to trigger uploading of a processed version of the selected multimedia content processed according to the multimedia processing operation on the social networking server 4 on behalf of the end user.

In this embodiment, the end user may process the selected multimedia content and thereby upload not the original version of the selected multimedia content as received from the network node 2, 2A but rather a processed version of the selected multimedia content. The multimedia processing operation could be any picture processing operation, video processing operation or audio processing operation that is applicable to the relevant type of selected multimedia content. For instance, the processing could be in the form of applying a filter to a picture, video or audio in order to achieve a desired picture, video or audio effect. As an example, Instagram uses different filters that an end user can select in order to get a filtered version of a photograph or picture. Other examples of multimedia processing operations include zooming in and out, adding effects such as blurring, etc.

The multimedia processing operation is preferably performed on the selected multimedia content in the communication device 1, such as using the previously mentioned social networking application running on the communication device 1. However, the resulting processed version of the selected multimedia content is not sent from the communication device 1 but rather information descriptive of the selected multimedia processing operation. This information is in the form of a processing command and/or a parameter. For instance, the processing command could define application of a filter whereas the parameter is an identifier of the selected filter. Correspondingly, the processing command could define a zooming action whereas the parameter defines the zooming level selected by the end user. In some situations the multimedia processing operation could be solely defined by a processing command, such as in the case where there is an alternative of not using a filter or using a single filter. In other situations it may be sufficient to define the parameter. For instance, when the parameter value defines a selected filter. In such a case, parameter value=1 represents filter no. 1, parameter value=2 represents filter no. 2 and so on. In this case, parameter value=0 represents no filter at all.

The processing command and/or parameter sent together with the index to the network node 2, 2B thereby enables performing the multimedia processing operation at the venue server 3 on the selected multimedia content defined by the index in order to get the processed version of the selected multimedia content. This processed version is then uploaded on the social networking server 4 on behalf of the end user.

Hence, these embodiments enable end users to select desired multimedia processing operations while still limiting the amount of uplink data that needs to be sent in order to upload multimedia content on social networking servers 4.

Another type of processing that can be done is to add text or other typed information to the selected multimedia content. In such a case, step S3 of FIG. 5 preferably comprises sending, to the network node 2, 2B, the index and text information entered by the end user on the communication device 1 to trigger uploading of the selected multimedia content or of the version of the selected multimedia content together with the text information on the social networking server 4 on behalf of the end user.

This means that the end user can enter text information using his/her communication device 1 that will be uploaded together with the selected multimedia content or the version of the selected multimedia content. Examples of such text information includes a tag of person or friend seen on a picture, text information defining the place at which the multimedia content was recorded, or any free text that the end user may want to add to the selected multimedia content.

Such text information can be represented with a low number of bits or bytes. Accordingly, sending the text information together with the index merely results in a small increase in the bandwidth and the total amount of data that needs to be sent from the communication device 1 to the network node 2, 2B in order to trigger uploading of the multimedia content and the text information.

The inclusion of text information can be combined with the previously described multimedia processing operation. In such a case, step S3 comprises sending, to the network node 2, 2B, the index, the text information and at least one of the processing command and the parameter to trigger uploading of a processed version of the selected multimedia content together with the text information on the social networking server 4 on behalf of the end user.

In an embodiment, step S1 of FIG. 5 comprises receiving a low quality version of the full multimedia content broadcasted or multicasted from the network node 2, 2A. In such a case, a high quality version of the full multimedia content is residing on the venue server 3. Step S3 then preferably comprises sending an index associated with a low quality version of the selected multimedia content to the network node 2, 2B to trigger uploading of a high quality version of the selected multimedia content on the social networking server 4 on behalf of the end user.

This embodiment reduces the amount of downlink data that is sent as broadcast or multicast to the communication devices 1 of end users by sending a low quality version of the full multimedia content. This low quality version of the full multimedia content preferably has a lower bit rate as compared to the high quality version of the full multimedia content. This means that the low quality version will not take up so much bandwidth as compared to sending the high quality version.

The end user can then select among the low quality version of the full multimedia content on the communication device 1. However, even though the end user has selected a low quality version and the communication device 1 sends an index associated with the low quality version of the selected multimedia content, the multimedia content uploaded on the social networking server 4 is the corresponding high quality version of the selected multimedia content.

The low quality version of the full multimedia content can be obtained by the venue server 3 according to various embodiments including, for instance, changing the quality be scaling, resolution or by changing format.

This embodiment thereby not only significantly reduces the requirements for uplink capacity but also the requirements for downlink capacity in order to enable end users to upload multimedia content on social networking servers 4.

The above described embodiments of sending index and identifier of the end user, sending index and at least one of a processing command and a parameter, and sending index and text information may be combined in various ways to send index, send index and identifier, send index and at least one of a processing command and a parameter, send index and text information, send index, identifier and at least one of a processing command and a parameter, send index, identifier and text information, send index, at least one of a processing command and a parameter and text information or send index, identifier, at least one of a processing command and a parameter and text information. Any of these combinations may additionally be combined by receiving a low quality version of the full multimedia content at the communication device but uploading a high quality version of the selected multimedia content or of the version of the selected multimedia content.

In an embodiment, the communication device receives feedback information, such as from a network node, representative of successful uploading of the selected multimedia content or of the version of the selected multimedia content. Such feedback information can thereby inform the end user that (the version of) the selected multimedia content has been successfully delivered to the social networking server and has been uploaded on the account of the end user at the social networking server.

For instance, the network node can send information or an update on the progress of transfer of the selected multimedia content or of the version of the selected multimedia content from the venue server to the social networking server. As an example, this information or update can indicate successful uploading. As another example, this information or update can be a session identifier and an indication of that the selected multimedia content or the version of the selected multimedia content was successfully delivered to the social networking server. In a further example, a number representing the percentage of bytes received so far by the social networking server of the selected multimedia content or of the version of the selected multimedia content could be sent to the communication device. This number is then typically between 0 and 100. In such a case, a fixed number, such as 100 or 101, could represent successful delivery of the complete multimedia content at the social networking server whereas another fixed number, such as 255, is used to indicate failed delivery. In this case, the update or information could be regarded as progress information.

The information or update can be transmitted to the communication device using unicast. Alternatively, the information or update is transmitted to the communication device using multicast. Multicast can be more efficient since the number of bytes that is sent is small and a unicast radio bearer for each communication device is then not needed.

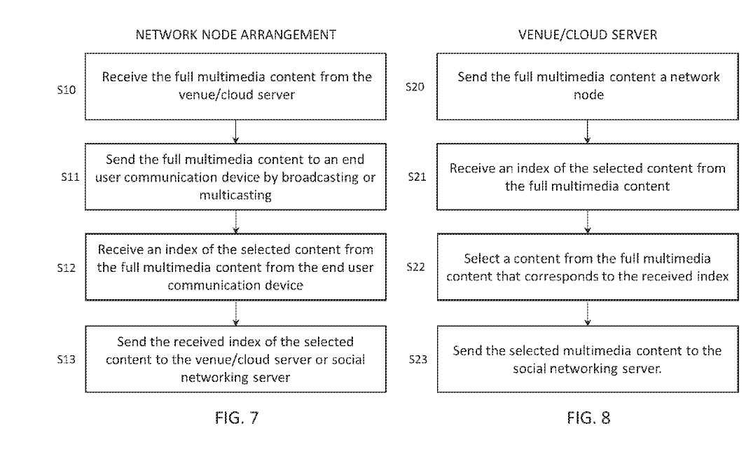

FIG. 7 is a flow chart of a method for a network node arrangement for uploading a multimedia content to a social networking server according to an embodiment. The method comprises receiving, in step S10, a full multimedia content from a venue server. The full multimedia content resides on the venue server. A next step S11 comprises broadcasting or multicasting the full multimedia content to a communication device of an end user. An index associated with a multimedia content selected from the full multimedia content is received in step S12 from the communication device. The received index is then sent in step S13 to trigger uploading of the selected multimedia content or of a version of the selected multimedia content on the social networking server on behalf of the end user.

The method of FIG. 7 is preferably performed by a network node arrangement. This network node arrangement could be in the form of a single network node 2 as shown in FIG. 2 or multiple, i.e. at least two, network nodes 2A, 2B as shown in FIGS. 3 and 4. This means that the steps or operations shown in FIG. 7 may be performed by or in a single network node 2 or by or in different network nodes 2A, 2B within the network node arrangement.

The transmission of the full multimedia content as a broadcast or multicast in step S11 is preferably taking place to multiple communication devices present within the coverage area of the network node arrangement, such as present at an area or sports field.

In an embodiment, step S13 comprises sending the received index to the venue server or to the social networking server to trigger uploading, by the venue server, of the selected multimedia content or of the version of the selected multimedia content on the social networking server on behalf of the end user.

FIGS. 2 and 3 illustrate the former situation in which the network node 2, 2B forwards the received index to the venue server 3. FIG. 4 is illustrates the latter situation in which the network node 2B forwards the received index to the social networking server 4, which in turn sends the index to the venue server 3. The situation in FIG. 4 is particularly applicable if the communication device 1 of the end user has a social networking application implemented for receiving and displaying the full multimedia content and sending the index associated with the multimedia content selected by the end user. In such a case, the social networking application could be implemented or preconfigured to communicate with the social networking server 4. This means that the transmission from the communication device 1 towards the venue server 3 is then taking place through the social networking server 4.

In an embodiment, step S12 of FIG. 7 comprises receiving the index and an identifier of the end user at the social networking server from the communication device. Step S13 then comprises sending the received index and the received identifier to trigger uploading of the selected multimedia content or of the version of the selected multimedia content on the social networking server on behalf of the end user identified by the received identifier.

The broadcast or multicasting of step S11 comprises, in an embodiment, broadcasting or multicasting the full multimedia content over a MBSFN channel to the communication device. In an embodiment, step S11 comprises broadcasting or multicasting the full multimedia content as an eMBMS transmission or as an eMBMS broadcast or multicast to the communication device 1. In a particular embodiment, step S11 comprises broadcasting or multicasting the full multimedia content as a LTE broadcast or multicast to the communication device.

Step S12 comprises, in an embodiment, receiving the index and at least one of a processing command and a parameter defining a selected multimedia processing operation for the selected multimedia content from the communication device. Step S13 then comprises sending the index and the at least one of the processing command and the parameter to trigger the venue server to upload a processed version of the selected multimedia content processed according to the multimedia processing operation on the social networking server on behalf of the end user.

In an embodiment, step S12 comprises receiving, from the communication device, the index and text information entered by the end user on the communication device. In this embodiment, step S13 comprises sending the received index and the text information to trigger uploading of the selected multimedia content or of the version of the selected multimedia content together with the text information on the social networking server on behalf of the end user.

In an embodiment, step S11 comprises broadcasting or multicasting a low quality version of the full multimedia content to the communication device. In this embodiment, the full multimedia content residing on the venue server is a high quality version of the full multimedia content. In such a case, step S13 preferably comprises sending a received index associated with a low quality version of the selected multimedia content to trigger the venue server to upload a high quality version of the selected multimedia content on the social networking server on behalf of the end user.

FIG. 8 is a flow chart illustrating a method for a venue server for uploading a multimedia content to a social networking server according to an embodiment. The method comprises sending a full multimedia content residing on the venue server to a network node in step S20. The following step S21 comprises receiving an index associated with a multimedia content selected by an end user from or among the full multimedia content. A multimedia content that corresponds to the received index is then selected in step S22 from the full multimedia content. The selected multimedia content or a version of the selected multimedia content is sent in step S23 to the social networking server to trigger uploading of the selected multimedia content or of the version of the selected multimedia content on the social networking server on behalf of the end user.

Hence, in a particular embodiment the venue server 3 is the entity that stores, internally or in a connected memory or server, the full multimedia content. The full multimedia content is provided to communication devices 1 of end users by means of the network node arrangement. In more detail, the venue server 3 sends the full multimedia content to at least one network node 2, 2A of the network node arrangement, which in turn broadcasts or multicasts the full multimedia content to the communication devices 1 as previously described herein.

The venue server 3 receives the index of or associated with the multimedia content selected by the end user. This index is typically either received from a network node 2, 2B of the network node arrangement, see FIGS. 2 and 3, or from the social networking server 4, see FIG. 4. The venue server 3 thereby uses the received index in order to identify and select the particular multimedia content among the full multimedia content that the end user would like to upload on the social networking server 4. Once the venue server 3 has identified and selected the multimedia content the venue server 3 uploads it or a version thereof on the social networking server 4 on behalf of the end user.

Accordingly, in an embodiment step S21 comprises receiving the index from a network node 2, 2B or from the social networking server 4.

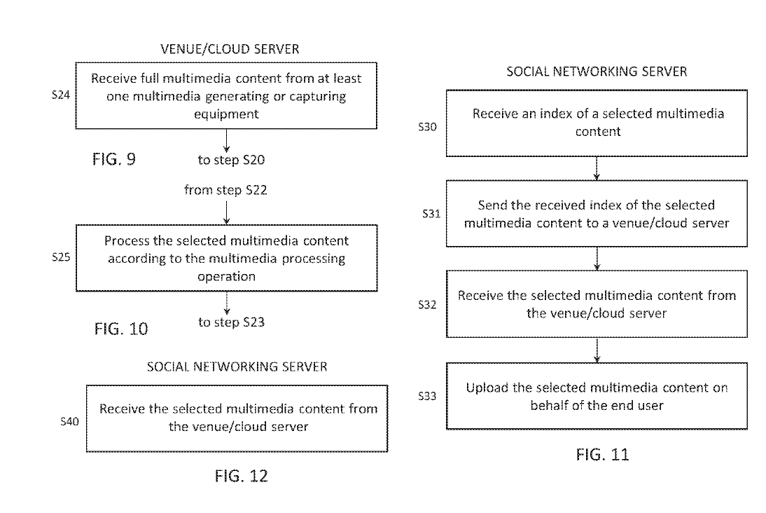

FIG. 9 is a flow chart of an additional, optional step of the method shown in FIG. 8. The method comprises receiving the full multimedia content from at least one multimedia generating or capturing equipment 5. Thus, one or more such multimedia generating or capturing equipment 5, such as in the form of digital cameras, video cameras or recorders, audio recorders, etc., takes pictures or records video and/or audio of, for instance, a social event, sports event or concert. The captured multimedia content is then forwarded to the venue server 3, where it is compiled and stored as the full multimedia content.

This means that it is possible to use one or more professional photographers or filmmakers 5 to provide or produce the full multimedia content. Alternatively, or in addition, one or a selected number of end users may have been assigned the role of multimedia content capturing user(s). The end user(s) will then take photographs, record video and/or record audio using his/her/their communication device(s) 1 and then transmit such taken or recorded multimedia content to the venue server 3. The venue server 3 then compiles the multimedia content from the end user(s) possibly also from the professional photographers and/or filmmakers to get the full multimedia content.

In an embodiment, step S21 of FIG. 8 comprises receiving the index and an identifier of the end user at the social networking server. In such a case, step S23 preferably comprises sending the selected multimedia content or the version of the selected multimedia content and the received identifier to the social networking server to trigger uploading of the selected multimedia content or of the version of the selected multimedia content on the social networking server on behalf of the end user identified by the received identifier.

FIG. 10 is a flow chart illustrating an additional, optional step of the method shown in FIG. 8. In this embodiment, step S21 of FIG. 8 comprises receiving the index and at least one of a processing command and a parameter defining a selected multimedia processing operation for the selected multimedia content. The method then continues to step S22 where the multimedia content is selected using the received index. A following step S25 of FIG. 10 comprises processing the selected multimedia content according to the multimedia processing operation defined by the received at least one of the processing command and the parameter to obtain a processed version of the selected multimedia content. The method then continues to step S23 of FIG. 8, which comprises sending the processed version of the selected multimedia content to the social networking server to trigger uploading of the processed version of the selected multimedia content on the social networking server on behalf of the end user.

In this embodiment, the venue server not only identifies and selects the multimedia content that the end user would like to upload on his/her account at the social networking server. The venue server furthermore processes the selected multimedia content according to a multimedia processing operation as defined by the received processing command and/or parameter. This means that the venue server uses the received processing command and/or parameter in order to select the particular multimedia processing operation that should be applied to the selected multimedia content in order to get the processed version of the selected multimedia content. This processed version is then sent to the social networking server where it is uploaded on behalf of the end user.

In an embodiment, step S21 of FIG. 8 comprises receiving the index and text information entered by the end user on the communication device. In such a case, step S23 preferably comprises sending the selected multimedia content or the version of the selected multimedia content and the text information to the social networking server to trigger uploading of the selected multimedia content or of the version of the selected multimedia content together with the text information on the social networking server on behalf of the end user.

In an embodiment, the full multimedia content residing on the venue server is a high quality version of the full multimedia content. In this embodiment, step S20 comprises sending a low quality version of the full multimedia content to the network node. Step S22 preferably comprises selecting a high quality version of a multimedia content that corresponds to the received index from the high quality version of the full multimedia content. This high quality version of the selected multimedia content is then sent in step S23 to the social networking server to trigger uploading of the high quality version of the selected multimedia content on the social networking server on behalf of the end users.

The venue server thereby has access to the full multimedia content in a high quality version and in a low quality version. The low quality version is sent to the network node and further on to the communication devices of the end users. This means that the bandwidth and the downlink radio resources needed to broadcast or multicast the full multimedia content to the end users can be significantly reduced by providing the low quality version of the full multimedia content instead of the high quality version of the full multimedia content. The end users thereby perform the selection among the low quality version of the full multimedia content. However, once the venue server receives indices associated with the respective selected multimedia content it identifies, selects and sends the corresponding high quality version of the respective selected multimedia content. This means that the version of the selected multimedia content that the social networking server receives and uploads on behalf of an end user is the high quality version of the selected multimedia content.

FIG. 11 is a flow chart of a method for a social networking server for uploading a multimedia content according to an embodiment. The method comprises receiving, in step S30, an index associated with a multimedia content selected by an end user from a full multimedia content residing on a venue server. The index is sent to the venue server in step S31. A following step S32 comprises receiving the selected multimedia content or a version of the selected multimedia content from the venue server. The selected multimedia content or the version of the selected multimedia content is then uploaded in step S33 on behalf of the end user.

In an embodiment, steps S31 and S32 thereby comprise requesting the selected multimedia content or the version of the selected multimedia content from the venue server based on or using the index.

This embodiment of the method thereby corresponds to the situation as shown in FIG. 4, in which the social networking server 4 receives the index and uses it to request the selected multimedia content or the version thereof from the venue server 3. The social networking server 4 then, once it has received the multimedia content from the venue server 3, uploads it on behalf of the end user.

In an embodiment, step S30 comprises receiving the index and an identifier of the end user at the social networking server. In such a case, step S33 preferably comprises uploading the selected multimedia content or the version of the selected multimedia content on behalf of the end user identified by the identifier.

In this embodiment, the social networking server preferably uses the received identifier to identify the end user and his/her account at the social networking server. The selected multimedia content or the version thereof is then uploaded on this identified account of the end user at the social networking server.

FIG. 12 is flow chart of a method for a social networking server for uploading a multimedia content according to another embodiment. The method comprises receiving a selected multimedia content from a venue server at which the multimedia content is selected from a full multimedia content residing on the venue server.

This embodiment of the method thereby corresponds to the situation as shown in FIGS. 2 and 3.

The venue server and/or the social networking server may be implemented as a respective single server in or connected to a communication network. Also distributed implementations are possible at multiple physical locations. The venue server and/or the social networking server may also be implemented in a cloud environment, i.e. as cloud servers or cloud-based/implemented servers.

The problem with congested networks at arenas has resulted in broadcast solutions, such as LTE Broadcast, also known as MBMS. This allows information to be broadcasted to the cell phones. This helps for some use cases, such as broadcasting sports statistics, video from a football game in another arena etc. to the arena audience. However, it does not help in the uplink situation, since the broadcast is downlink only.

The idea of embodiments of the present invention is to extend a social networking app, such as Instagram, with capability that allows it to receive images and video over, for instance, LTE Broadcast. These images and videos are created by the event organizers. In the case of a concert, a professional photographer will take snapshots of the artist. These photos will be downloaded to the Instagram app on the phone using a broadcast method, e.g. LTE Broadcast. The end user can then select one of these images and “upload” them to his/her personal Instagram feed. However, when hitting the “upload” button, the image is not technically uploaded from the phone to Instagram's server. Instead it sends a command to a server, where the images also reside, with an index of the image to be uploaded (e.g. image number X) to upload the selected image (image number X) to Instagram on behalf of the end user. Hence only the command needs to be sent over the uplink, which is much less demanding in terms of uplink capacity than sending the image itself.

In the proposed solution, the end user never uploads the image as an example of multimedia content over the mobile, e.g. 4G, network; instead it uploads a command including the index (identity) of the image he/she wants to upload. This takes much less capacity than sending the actual image. This is where the savings come in. Hence the uplink is replaced by downloading. However, since the image is downloaded to the Instagram app using LTE Broadcast, this does not take much radio resources either, since all phones in the arena can listen to the same LTE Broadcast.

It is likely that the end users would like to share the photos of the event itself, for example a concert stage or a goal in a football game. However, they may also want to prove that they were there. Therefore it is also possible to have a scenario where the professional photographer 5 takes photos of the audience and the end users could select the ones where they are visible.

The end users may want to make a bit of a “personal touch” on the received professional content. There are several ways of putting an own twist on the photo: for instance changing the photo by selecting a filter, zooming in and adding effects such as blurring etc. This processing can be executed in the phone 1 in order to give the user a preview, but instead of sending the processed image, processing commands and parameters are sent along with the image identity. The final processing will be done in the cloud (venue/cloud server 3 in FIG. 2) and the resulting image, together with the status text, will then be forwarded to the Instagram server 4.

Another possibility is to add things that do not take up so much bandwidth. Of course the end user is able to enter his/her own text associated with the image/video; that is very low in bandwidth and should therefore not be a problem. Another possibility is to add or replace the sound of the video clip—this is higher in terms of bitrate, but still not as bad as the video. That would make the clip more unique and could better be used to prove that the end user was really there.

With video it is possible to have an even more personalized version: a live video feed can be broadcasted over LTE Broadcast to the smartphone 1, and at any point in time the end user can hit a virtual snapshot button. This means that the end user has selected this particular video frame as the image to upload. Unless some other end user happens to select exactly the same frame (which is highly unlikely), the image will at least be unique, even if it is not going to be taken by the end user him/herself or even from the end user's point of view. The video frame sent to Instagram 4 from the venue/cloud server 3 can be of higher quality/resolution than the video frame that was sent to the phone 1 over LTE Broadcast. Another possibility is for the LTE Broadcast system to include this frame in the list of image sent out over LTE Broadcast, so that the smartphone 1 actually can see the high resolution video frame for processing.

### Example Embodiments

An aspect of the embodiments defines a method for an end user communication device for uploading a multimedia content to a social networking server, wherein the multimedia content is selected from a full multimedia content that resides on a venue/cloud server, the method comprising:
Receiving the full multimedia content broadcasted from a network node;
Selecting a content from the full multimedia content that will be uploaded to the social networking server on behalf of an end user;
Sending an index associated with the selected content to the network node.

Another aspect of the embodiments defines a method for a network node for uploading a multimedia content to a social networking server, wherein the multimedia content is selected from a full multimedia content that resides on a venue/cloud server, the method comprising:
Receiving the full multimedia content from the venue/cloud server;
Sending the full multimedia content to an end user communication device by broadcasting;
Receiving an index associated with the selected content from the full multimedia content from the end user communication device;
Sending the received index associated with the selected content to the venue/cloud server.

Another aspect of the embodiments defines a method for a venue/cloud server for uploading a multimedia content to a social networking server, wherein the multimedia content is selected from a full multimedia content that resides on the venue/cloud server, the method comprising:
Sending the full multimedia content a network node;
Receiving an index associated with the selected content from the full multimedia content from a network node;
Selecting a content from the full multimedia content that corresponds to the received index;
Sending the selected multimedia content to the social networking server.

Another aspect of the embodiments defines a method for a social networking server for uploading a multimedia content, wherein the multimedia content is selected from a full multimedia content that resides on a venue/cloud server, the method comprising receiving the selected multimedia content from the venue/cloud server.

### Implementation Aspect

An aspect of the embodiments relates to a communication device configured to send, to a network node, an index associated with a multimedia content selected from a full multimedia content broadcasted or multicasted from a network node to trigger uploading of the selected multimedia content or of a version of the selected multimedia content on a social networking server on behalf of an end user of the communication device.

In an embodiment, the communication device is configured to receive the full multimedia content broadcasted or multicasted from the network node. The communication device is also configured to generate the index associated with the multimedia content selected from the full multimedia content. The communication device is further configured to send the index to the network node to trigger uploading of the selected multimedia content or of the version of the selected multimedia content on the social networking server on behalf of the end user.

In an embodiment the communication device is configured to send the index and an identifier of the end user at the social networking server to the network node to trigger uploading of the selected multimedia content or of the version of the selected multimedia content on the social networking server on behalf of the end user identified by the identifier.

In an embodiment, the communication device is configured to receive the full multimedia content over a MBSFN channel from the network node. The communication device is preferably configured to receive the full multimedia content as an eMBMS transmission or as an eMBMS broadcast or multicast from the network node. Thus, in an embodiment the communication device is configured to receive the full multimedia content as a LTE broadcast or multicast from the network node.

In an embodiment, the communication device is configured to download or stream, using a broadcast or multicast transmission from the network node, the full multimedia content to a social networking application running on the communication device. Hence, the full multimedia content is broadcasted or multicasted and received as downloaded or streamed multimedia content in the social networking application.

In an embodiment, the communication device is configured to select a multimedia processing operation for the selected multimedia content. The communication device is also configured to send the index and at least one of a processing command and a parameter defining the selected multimedia processing operation to the network node to trigger uploading of a processed version of the selected multimedia content processed according to the multimedia processing operation on the social networking server on behalf of the end user.

In an embodiment, the communication device is configured to send, to the network node, the index and text information entered by the end user on the communication device to trigger uploading of the selected multimedia content or of the version of the selected multimedia content together with the text information on the social networking server on behalf of the end user.

In an embodiment, the communication device is configured to receive a low quality version of the full multimedia content broadcasted or multicasted from the network node. In this embodiment, a high quality version of the full multimedia content is residing on a venue server. The communication device is also configured to send an index associated with a low quality version of the selected multimedia content to the network node to trigger uploading of a high quality version of the selected multimedia content on the social networking server on behalf of the end user.

In the above described embodiments, when the communication device selects the multimedia content or selects a multimedia processing operation it preferably performs the selection based on a user input of the end user. For instance, the end user may activate a user input, such as touch-sensitive screen or key, of the communication device to thereby trigger or cause the communication device to select the multimedia content or the multimedia processing operation.

The communication device can be any user device or equipment capable of receiving multimedia content in the form of a broadcast or multicast from a network node. Examples of such communication devices include smartphones, mobile telephones, laptops, tablets, etc. The communication device is preferably a portable, and in particular a hand-held, device that the end user can bring and use at a social event, sports event or music event, etc.

Another aspect of the embodiments relates to a network node arrangement. The network node arrangement is configured to broadcast or multicast a full multimedia content received from a venue server housing the full multimedia content. The network node arrangement is also configured to send an index associated with a multimedia content selected by an end user from the full multimedia content to trigger uploading of the selected multimedia content or of a version of the selected multimedia content on a social networking server on behalf of the end user.

In an embodiment, the network node arrangement is configured to receive the full multimedia content from the venue server. The network node arrangement is also configured to broadcast or multicast the full multimedia content to a communication device of the end user. The network node arrangement is further configured to receive, from the communication device, the index associated with the multimedia content selected form the full multimedia content. The network node arrangement is additionally configured to send the received index to trigger uploading of the selected multimedia content or of the version of the selected multimedia content on the social networking server on behalf of the end user.

In an embodiment, the network node arrangement is configured to send the received index to the venue server or to the social networking server to trigger uploading, by the venue server, of the selected multimedia content or of the version of the selected multimedia content on the social networking server on behalf of the end user.

In an embodiment, the network node arrangement is configured to receive the index and an identifier of the end user at the social networking server from the communication device. The network node arrangement is also configured to send the received index and the received identifier to trigger uploading of the selected multimedia content or of the version of the selected multimedia content on the social networking server on behalf of the end user identified by the received identifier.

In an embodiment, the network node arrangement is configured to broadcast or multicast the full multimedia content over a MBSFN channel to the communication device. Thus, the network node arrangement is preferably configured to broadcast or multicast the full multimedia content as an eMBMS transmission or as an EBMMS broadcast or multicast to the communication device. The network node arrangement is thereby preferably configured to broadcast or multicast the full multimedia content as a LTE broadcast or multicast to the communication device.

In an embodiment, the network node arrangement is configured to receive, from the communication device, the index and at least one of a processing command and a parameter defining a selected multimedia processing operation for the selected multimedia content. The network node arrangement is also configured to send the received index and the at least one of the processing command and the parameter to trigger the venue server to upload a processed version of the selected multimedia content processed according to the multimedia processing operation on the social networking server on behalf of the end user.

In an embodiment, the network node arrangement is configured to receive, from the communication device, the index and text information entered by the end user on the communication device. The network node arrangement is also configured to send the received index and the text information to trigger uploading of the selected multimedia content or of the version of the selected multimedia content together with the text information on the social networking server on behalf of the end user.

In an embodiment, the network node arrangement is configured to broadcast or multicast a low quality version of the full multimedia content to the communication device. The full multimedia content residing on the venue server is then a high quality version of the full multimedia content. The network node arrangement is also configured to send a received index associated with a low quality version of the selected multimedia content to trigger the venue server to upload a high quality version of the selected multimedia content on the social networking server on behalf of the end user.

The network node arrangement could be in the form of a single network node or be implemented at multiple network nodes to achieve a distributed implementation of its functionalities. The at least one network node is preferably in the form of a base station, Node-B, eNode-B or radio access point implemented in a communication network, preferably in a radio-based or cellular communication network.

A further aspect of the embodiments relates to a venue server configured to send, to a social networking server, a multimedia content selected based on a received index associated with a multimedia content selected by an end user from a full multimedia content residing on the venue server to trigger uploading of the selected multimedia content or of a version of the selected multimedia content on the social networking server on behalf of the end user.

In an embodiment, the venue server is configured to send the full multimedia content residing on the venue server to a network node. The venue server is also configured to receive the index associated with the multimedia content selected by the end user from the full multimedia content. The venue server is further configured to select a multimedia content that corresponds to the received index from the full multimedia content. The venue server is additionally configured to send the selected multimedia content or the version of the selected multimedia content to the social networking server to trigger uploading of the selected multimedia content or of the version of the selected multimedia content on the social networking server on behalf of the end user.

In an embodiment, the venue server is configured to receive the index from a network node or from the social networking server.

In an embodiment, the venue server is configured to receive the index and an identifier of the end user at the social networking server. The venue server is also configured to send the selected multimedia content or the version of the selected multimedia content and the received identifier to the social networking server to trigger uploading of the selected multimedia content or of the version of the selected multimedia content on the social networking server on behalf of the end user identified by the received identifier.

In an embodiment, the venue server is configured to receive the full multimedia content from at least one multimedia generating or capturing equipment.

In an embodiment, the venue server is configured to receive the index and at least one of a processing command and a parameter defining a selected multimedia processing operation for the selected multimedia content. The venue server is also configured to process the selected multimedia content according to the multimedia processing operation defined by the received at least one of the processing command and the parameter to obtain a processed version of the selected multimedia content. The venue server is further configured to send the processed version of the selected multimedia content to the social networking server to trigger uploading of the processed version of the selected multimedia content on the social networking server on behalf of the end user.

In an embodiment, the venue server is configured to receive the index and text information entered by the end user on the communication device. The venue server is also configured to send the selected multimedia content or the version of the selected multimedia content and the text information to the social networking server to trigger uploading of the selected multimedia content or of the version of the selected multimedia content together with the text information on the social networking server on behalf of the end user.

In an embodiment, the venue server is configured to send a low quality version of the full multimedia content to the network node. The full multimedia content residing on the venue server is a high quality version of the full multimedia content. The venue server is also configured to select a high quality version of a multimedia content from the high quality version of the full multimedia content that corresponds to the received index. The venue server is further configured to send the high quality version of the selected multimedia content to the social networking server to trigger uploading of the high quality version of the selected multimedia content on the social networking server on behalf of the end user.

The venue server could be in the form of a single server or be implemented at multiple locations to achieve a distributed implementation of its functionalities. Thus, the venue server could be in the form of multiple distributed servers that co-process or together perform the operations of the venue server as described above. Also a cloud-based or cloud-implemented venue server is possible and within the scope of the present embodiments.

Yet another aspect of the embodiments defines a social networking server configured to send, to a venue server, an index associated with a multimedia content selected by an end user from a full multimedia content residing on the venue server. The social networking server is also configured to upload, on behalf of the end user, the selected multimedia content or a version of the selected multimedia content received from the venue server.

In an embodiment, the social networking server is configured to receive the index associated with the multimedia content selected by the end user from the full multimedia content residing on the venue server. The social networking server is also configured to send the index to the venue server. The social networking server is further configured to receive the selected multimedia content or the version of the selected multimedia content from the venue server. The social networking server is additionally configured to upload the selected multimedia content or the version of the selected multimedia content on behalf of the end user.

In an embodiment, the social networking server is configured to receive the index and an identifier of the end user at the social networking server. The social networking server is also configured to upload the selected multimedia content or the version of the selected multimedia content on behalf of the end user identified by the identifier.

The social networking server could be in the form of a single server or be implemented at multiple locations to achieve a distributed implementation of its functionalities. Thus, the social networking server could be in the form of multiple distributed servers that co-process or together perform the operations of the social networking server as described above. Also a cloud-based or cloud-implemented social networking server is possible and within the scope of the present embodiments. The social networking server is preferably the server of a social networking service provider, such as Instagram, Facebook or any other social media or social networking service provider. More generally, the social networking server can be any server or server network at which end users can upload multimedia content as described herein. Accordingly, the social networking server does not necessarily need to be provided by Instagram, Facebook or similar currently available social networking service providers.

It will be appreciated that the methods, devices, servers and arrangements described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

FIG. 14 illustrates a particular hardware implementation of a communication device 110 according to an embodiment. The communication device 110 comprises a receiver 112 configured to receive the full multimedia content broadcasted or multicasted from the network node. The communication device 110 also comprises a selector 113 configured to generate the index associated with the multimedia content selected from the full multimedia content. The communication device 110 further comprises a sender configured to send the index to the network node to trigger uploading of the selected multimedia content or of the version of the selected multimedia content on the social networking server on behalf of the end user.

The receiver 112 is preferably connected to the selector in order to forward the received full multimedia content thereto. The selector 113 is in turn preferably connected to the sender 111 in order to provide the sender 111 with the index associated with the selected multimedia content.

The selector 113 is preferably configured to generate the index based on activation of a user input, such as touch-sensitive screen or key, of the communication device 110.

The sender 111 is preferably in the form of a transmitter. Alternatively, the sender 111 and the receiver 112 could be implemented as a common transceiver.

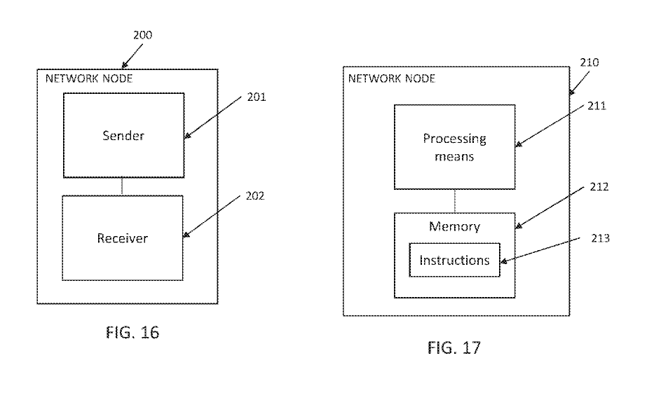

FIG. 16 illustrates a particular hardware implementation of a network node arrangement 200 according to an embodiment. The network node arrangement 200 preferably comprises a receiver 202 configured to receive the full multimedia content from the venue server and receive, from the communication device, the index associated with the multimedia content selected from the full multimedia content. The network node arrangement 200 also comprises a sender 201 configured to broadcast or multicast the full multimedia content to the communication device and send the received index to trigger uploading of the selected multimedia content or of the version of the selected multimedia content on the social networking server on behalf of the end user.

The sender 201 and receiver 202 are preferably interconnected to forward the full multimedia content and the index therebetween.

The sender 201 is preferably in the form of a transmitter. Alternatively, the sender 201 and the receiver 202 could be implemented as a common transceiver. The sender 201 may also be in the form of a transmitter and an output port and/or the receiver 202 may be in the form of a receiver and an input port. The input and output ports may then be used for wired communication, for instance, between the network node arrangement and the venue server and/or between the network node arrangement and the social networking server. In such a case, the transmitter and receiver, optionally in the form as a common transceiver, are then used for wireless communication with communication devices.

FIG. 19 illustrates a particular hardware implementation of a venue server 310 according to an embodiment. The venue server 310 comprises a sender 311 configured to send the full multimedia content residing on the venue server 310 to a network node. The venue server 310 also comprises a receiver 312 configured to receive the index associated with the multimedia content selected by the end user from the full multimedia content. The venue server 310 further comprises a selector 313 configured to select a multimedia content that corresponds to the received index from the full multimedia content. The sender 311 is preferably configured to send the selected multimedia content or the version of the selected multimedia content to the social networking serer to trigger uploading of the selected multimedia content or of the version of the selected multimedia content on the social networking server on behalf of the end user.

The receiver 312 is preferably connected to the selector 313 to forward the received index thereto. The selector 313 is in turn preferably connected to the sender 311 in order to forward the selected multimedia content or the version of the selected multimedia content thereto.

The sender 311 and receiver 312 may be implemented as a transmitter and receiver pair, as a common transceiver or as an output port and an input port.

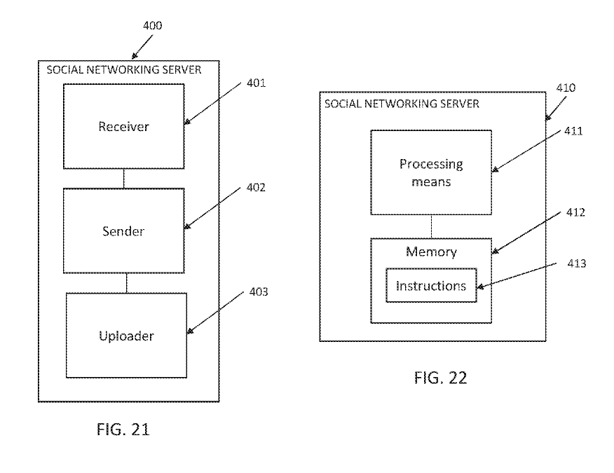

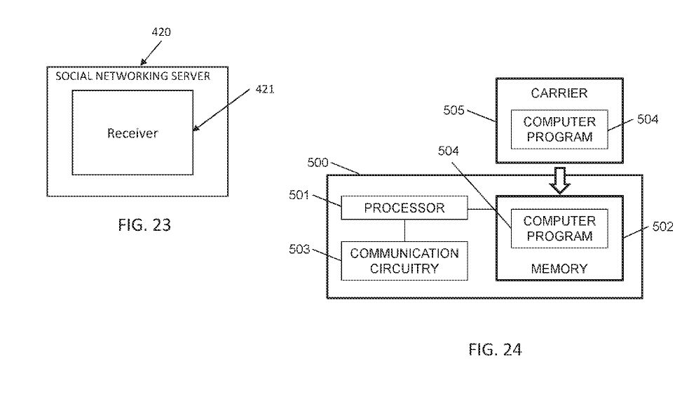

FIG. 21 illustrates a particular hardware implementation of a social networking server 400 according to an embodiment. The social networking server 400 comprises a receiver 401 configured to receive the index. The social networking server 400 also comprises a sender 402 configured to send the index to the venue server. The receiver 401 is preferably also configured to receive the selected multimedia content or the version of the selected multimedia content from the venue server. The social networking server 400 further comprises an uploader 403 configured to upload the selected multimedia content or the version of the selected multimedia content on behalf of the end user.

The receiver 401 is preferably connected to the sender 402 to forward the index thereto. The sender 402 is in turn preferably connected to the uploader 403 in order to forward the selected multimedia content or the version of the selected multimedia content thereto.

The sender 402 and receiver 401 may be implemented as a transmitter and receiver pair, as a common transceiver or as an output port and an input port.

Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g. by reprogramming of the existing software or by adding new software components.

In a particular example, the communication device 120, see FIG. 15, comprises a processor 121, represented by processing means in the figure, and a memory 122 comprising instructions 123, which when executed by the processor 121, cause the processor 121 to receive the full multimedia content broadcasted or multicasted from the network node. The processor 121 is also caused to generate the index associated with the multimedia content selected from the full multimedia content. The processor 121 is further caused to send the index to the network node to trigger uploading of the selected multimedia content or of the version of the selected multimedia content on the social networking server on behalf of the end user.

FIG. 17 illustrates an embodiment of a network node arrangement 210 comprising a processor 211, represented by processing means in the figure, and a memory 212 comprising instructions 213, which when executed by the processor 211, cause the processor 211 to receive the full multimedia content from the venue server and broadcast or multicast the full multimedia content to the communication device. The processor 211 is also caused to receive, from the communication device, the index associated with the multimedia content selected by the full multimedia content. The processor 211 is further caused to send the received index to trigger uploading of the selected multimedia content or of the version of the selected multimedia content on the social networking server on behalf of the end user.

FIG. 20 illustrates an embodiment of a venue server 320 comprising a processor 321, represented by processing means in the figure, and a memory 322 comprising instructions 323, which when executed by the processor 321, cause the processor 321 to send the full multimedia content residing on the venue server 320 to a network node and receive the index associated with the multimedia content selected by the end user from the full multimedia content. The processor 321 is also caused to select a multimedia content that corresponds to the received index from the full multimedia content. The processor 321 is further caused to send the selected multimedia content or the version of the selected multimedia content to the social networking server to trigger uploading of the selected multimedia content or of the version of the selected multimedia content on the social networking server on behalf of the end user.

In an embodiment, the full multimedia content is preferably stored in the memory 322 of the venue server 320.

FIG. 22 illustrates an embodiment of a social networking server 410 comprising a processor 411, represented by processing means in the figure, and a memory 412 comprising instructions 413, which when executed by the processor 411, cause the processor 411 to receive the index and send the index to the venue server. The processor 411 is also caused to receive the selected multimedia content or the version of the selected multimedia content and upload the selected multimedia content or the version of the selected multimedia content on behalf of the end user.

In a particular embodiment, the processor 121, 211, 321, 411 in FIGS. 15, 17, 19 and 22 is operative, when executing the instructions 123, 213, 323, 413 stored in the memory 122, 212, 322, 412 to perform the above described operations. The processor 121, 211, 321, 411 is thereby interconnected to the memory 122, 212, 322, 412 to enable normal software execution.

In a particular example, at least some of the steps, functions, procedures, modules and/or blocks described herein are implemented in a computer program 504, which is loaded into a memory 502 for execution by processing circuitry including one or more processors 501 as shown in FIG. 24. The processor 501 and memory 502 are interconnected to each other to enable normal software execution.

A communication circuitry 503 is also interconnected to the processor 501 and/or the memory 502 to enable input and/or output of data.

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

In an embodiment, the computer program 504 comprises instructions, which when executed by the processor 501, cause the processor 501 to provide for transmission, to a network node, of an index associated with a multimedia content selected from a full multimedia content broadcasted or multicasted from a network node to trigger uploading of the selected multimedia content or of a version of the selected multimedia content on a social networking server on behalf of an end user.

In another embodiment, the computer program 504 comprises instructions, which when executed by the processor 501, cause the processor 501 to output for broadcast or multicast of a full multimedia content received from a venue server housing the full multimedia content. The processor 501 is also caused to send an index associated with a multimedia content selected by an end user from the full multimedia content to trigger uploading of the selected multimedia content or of a version of the selected multimedia content on a social networking server on behalf of the end user.

In a further embodiment, the computer program 504 comprises instructions, which when executed by the processor 501, cause the processor 501 to provide for transmission, to a social networking server, of a multimedia content selected based on a received index associated with a multimedia content selected by an end user from a full multimedia content residing on a venue server to trigger uploading of the selected multimedia content or of a version of the selected multimedia content on the social networking server on behalf of the end user.

In yet another embodiment, the computer program 504 comprises instructions, which when executed by the processor 501, cause the processor 501 to provide for transmission, to a venue server, of an index associated with a multimedia content selected by an end user from a full multimedia content residing on the venue server. The processor 501 is also caused to upload, on behalf of the end user, the selected multimedia content or a version of the selected multimedia content received from the venue server.

The proposed technology also provides a carrier 505 comprising the computer program 504. The carrier 505 is one of an electronic signal, an optical signal, an electromagnetic signal, a magnetic signal, an electric signal, a radio signal, a microwave signal, or a computer-readable storage medium 505.

By way of example, the software or computer program 504 may be realized as a computer program product, which is normally carried or stored on a computer-readable medium 505, preferably non-volatile computer-readable storage medium 505. The computer-readable medium 505 may include one or more removable or non-removable memory devices including, but not limited to a Read-Only Memory (ROM), a Random Access Memory (RAM), a Compact Disc (CD), a Digital Versatile Disc (DVD), a Blue-ray disc, a Universal Serial Bus (USB) memory, a Hard Disk Drive (HDD) storage device, a flash memory, a magnetic tape, or any other conventional memory device. The computer program 505 may thus be loaded into the operating memory of a computer or equivalent processing device, represented by a general device, server or arrangement 500 in FIG. 24, for execution by the processor 501 thereof.

The flow diagram or diagrams presented herein may therefore be regarded as a computer flow diagram or diagrams, when performed by one or more processors. A corresponding communication device or venue server may be defined as a group of function modules, where each step performed by the processor corresponds to a function module. In this case, the function modules are implemented as a computer program running on the processor. Hence, the communication device and/or venue server may alternatively be defined as a group of function modules, where the function modules are implemented as a computer program running on at least one processor.

The computer program residing in memory may thus be organized as appropriate function modules configured to perform, when executed by the processor, at least part of the steps and/or tasks described herein.

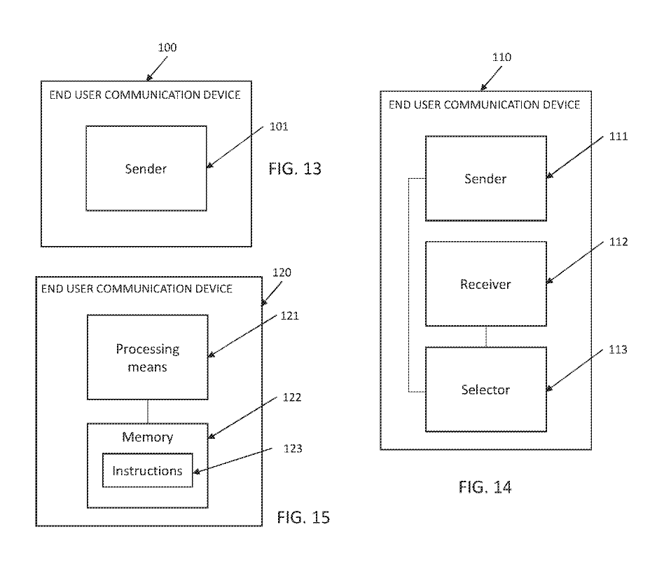

FIG. 13 is a schematic block diagram of a communication device 100 with function modules. The communication device 100 comprises a sender 101 for sending, to a network node, an index associated with a multimedia content selected from a full multimedia content broadcasted or multicasted from a network node to trigger uploading of the selected multimedia content or of a version of the selected multimedia content on a social networking server on behalf of an end user of the communication device 100.

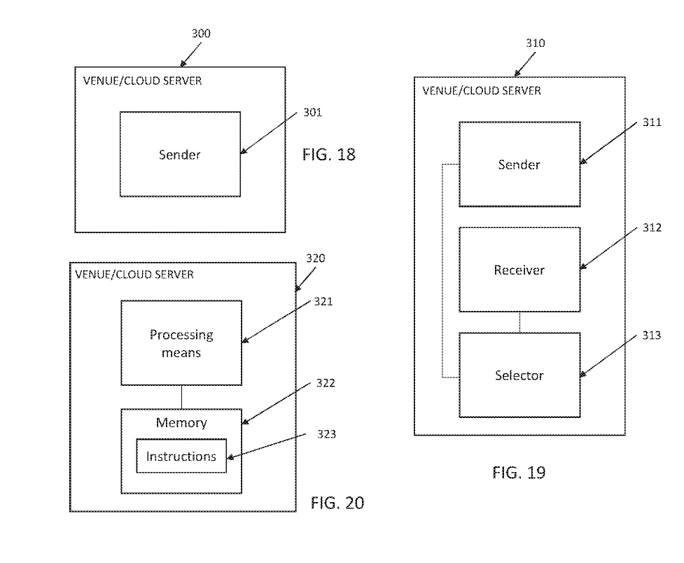

FIG. 18 is a schematic block diagram of a venue server 300 with function modules. The venue server 300 comprises a sender 301 for sending, to a social networking server, a multimedia content selected based on a received index associated with a multimedia content selected by an end user from a full multimedia content residing on the venue server 300 to trigger uploading of the selected multimedia content or of a version of the selected multimedia content on the social networking server on behalf of the end user.

### Example Embodiments

A further aspect of the embodiments defines an end user communication device for uploading a multimedia content to a social networking server, wherein the multimedia content is selected from a full multimedia content that resides on a venue/cloud server, the end user communication device comprising processing means and a memory comprising instructions which, when executed by the processing means, causes the end user communication device to:
Receive the full multimedia content broadcasted from a network node;
Select a content from the full multimedia content that will be uploaded to the social networking server on behalf of an end user;
Send an index associated with the selected content to the network node.

The end user communication device could also comprise a receiver, configured to receive the full multimedia content broadcasted from a network node, a selector configured to select a content from the full multimedia content that will be uploaded to the social networking server on behalf of a communication device user, and a sender configured to send an index associated with the selected content to the network node.

A further aspect of the embodiments defines a network node for uploading a multimedia content to a social networking server, wherein the multimedia content is selected from a full multimedia content that resides on a venue/cloud server, the network node comprising processing means and a memory comprising instructions which, when executed by the processing means, causes the network node to:
Receive the full multimedia content from the venue/cloud server;
Send the full multimedia content to an end user communication device by broadcasting;
Receive an index associated with the selected content from the full multimedia content from the end user communication device;
Send the received index for the selected content to the venue/cloud server.

The network node could also comprise a receiver configured to receive the full multimedia content from the venue/cloud server and an index associated with the selected content from the full multimedia content from the end user communication device and a sender configured to send the full multimedia content to an end user communication device by broadcasting and the received index for the selected content to the venue/cloud server.

Another aspect of the embodiments defines a venue/cloud server for uploading a multimedia content to a social networking server, wherein the multimedia content is selected from a full multimedia content that resides on the venue/cloud server, the venue/cloud server comprising processing means and a memory comprising instructions which, when executed by the processing means, causes the venue/cloud server to:
Send the full multimedia content a network node;
Receive an index associated with the selected content from the full multimedia content from a network node;
Select a content from the full multimedia content that corresponds to the received index;
Send the selected multimedia content to the social networking server.

The venue/cloud server could also comprise a sender configured to send the full multimedia content to a network node and the selected multimedia content to the social networking server, a receiver configured to receive an index for the selected content from the full multimedia content from a network node, and a selector configured to select a content from the full multimedia content that corresponds to the received index.

Another aspect of the embodiments defines a social networking server for uploading a multimedia content, wherein the multimedia content is selected from a full multimedia content that resides on a venue/cloud server, the social networking server comprising processing means and a memory comprising instructions which, when executed by the processing means, causes the social networking server to receive the selected multimedia content from the venue/cloud server.

The social networking server could also comprise a receiver configured to receive the selected multimedia content from the venue/cloud server.

A further aspect of the embodiments defines a computer program for an end user communication device comprising a computer program code which, when executed, causes the end user communication device to:
Receive the full multimedia content broadcasted from a network node;
Select a content from the full multimedia content that will be uploaded to the social networking server on behalf of an end user;
Send an index associated with the selected content to the network node.

Another aspect of the embodiments defines a computer program for a network node comprising a computer program code which, when executed, causes the network node to:
Receive the full multimedia content from the venue/cloud server;
Send the full multimedia content to an end user communication device by broadcasting;
Receive an index associated with the selected content from the full multimedia content from the end user communication device;
Send the received index associated with the selected content to the venue/cloud server.

Another aspect of the embodiments defines a computer program for a venue/cloud server comprising a computer program code which, when executed, causes the venue/cloud server to:
Send the full multimedia content a network node;
Receive an index associated with the selected content from the full multimedia content from a network node;
Select a content from the full multimedia content that corresponds to the received index;
Send the selected multimedia content to the social networking server.

Another aspect of the embodiments defines a computer program for a social networking server comprising a computer program code which, when executed, causes the social networking server to receive the selected multimedia content from the venue/cloud server.

A further aspect of the embodiments defines a computer program product for an end user communication device comprising a computer program for an end user communication device and a computer readable means on which the computer program for an end user communication device is stored.

Another aspect of the embodiments defines a computer program product for a network node comprising a computer program for a network node and a computer readable means on which the computer program for a network node is stored.

Another aspect of the embodiments defines a computer program product for a venue/cloud server comprising a computer program for a venue/cloud server and a computer readable means on which the computer program for a venue/cloud server is stored.

Another aspect of the embodiments defines a computer program product for a social networking server comprising a computer program for a social networking server and a computer readable means on which the computer program for social networking server is stored.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1-57. (canceled)

58. A method for a communication device of an end user for uploading a multimedia content to a social networking server, said method comprising:
receiving a full multimedia content broadcasted or multicasted from a network node of a communication network;
selecting a multimedia content from said full multimedia content; and
sending an index associated with said selected multimedia content to the same or another network node, to trigger uploading of said selected multimedia content or a version of said selected multimedia content on said social networking server on behalf of said end user.

59. The method according to claim 58, wherein sending said index comprises sending said index and an identifier of said end user at said social networking server to said same or other network node, to trigger uploading of said selected multimedia content or said version of said selected multimedia content on said social networking server on behalf of said end user identified by said identifier.

60. The method according to claim 58, further comprising selecting a multimedia processing operation for said selected multimedia content, wherein sending said index comprises sending said index and at least one of a processing command and a parameter defining said selected multimedia processing operation to said same or other network node, to trigger uploading of a processed version of said selected multimedia content processed according to said multimedia processing operation on said social networking server on behalf of said end user.

61. The method according to claim 58, wherein sending said index comprises sending, to said same or other network node, said index and text information entered by said end user on said communication device to trigger uploading of said selected multimedia content or said version of said selected multimedia content together with said text information on said social networking server on behalf of said end user.

62. The method according to claim 58, wherein
receiving said full multimedia content comprises receiving a low quality version of said full multimedia content broadcasted or multicasted from said network node of the communication network, wherein a high quality version of said full multimedia content is residing on a venue server; and
sending said index comprises sending an index associated with a low quality version of said selected multimedia content to said same or other network node to trigger uploading of a high quality version of said selected multimedia content on said social networking server on behalf of said end user.

63. A method performed by an arrangement implemented in one or more network nodes of a communication network, for uploading a multimedia content to a social networking server, said method comprising:
receiving a full multimedia content from a venue server, wherein said full multimedia content resides on said venue server;
broadcasting or multicasting said full multimedia content to a communication device of an end user;
receiving, from said communication device, an index associated with a multimedia content selected from said full multimedia content; and
sending said received index to trigger uploading of said selected multimedia content or a version of said selected multimedia content on said social networking server on behalf of said end user.

64. The method according to claim 63, wherein
receiving said index comprises receiving said index and an identifier of said end user at said social networking server from said communication device; and
sending said received index comprises sending said received index and said received identifier to trigger uploading of said selected multimedia content or said version of said selected multimedia content on said social networking server on behalf of said end user identified by said received identifier.

65. The method according to claim 63, wherein
receiving said index comprises receiving said index and at least one of a processing command and a parameter defining a selected multimedia processing operation for said selected multimedia content from said communication device; and
sending said received index comprises sending said received index and said at least one of said processing command and said parameter to trigger said venue server to upload a processed version of said selected multimedia content processed according to said multimedia processing operation on said social networking server on behalf of said end user.

66. The method according to claim 63, wherein
receiving said index comprises receiving, from said communication device, said index and text information entered by said end user on said communication device; and
sending said received index comprises sending said received index and said text information to trigger uploading of said selected multimedia content or of said version of said selected multimedia content together with said text information on said social networking server on behalf of said end user.

67. The method according to claim 63, wherein
broadcasting or multicasting said full multimedia content comprises broadcasting or multicasting a low quality version of said full multimedia content to said communication device, wherein said full multimedia content residing on said venue server is a high quality version of said full multimedia content; and
sending said received index comprises sending a received index associated with a low quality version of said selected multimedia content to trigger said venue server to upload a high quality version of said selected multimedia content on said social networking server on behalf of said end user.

68. A method for a venue server for uploading a multimedia content to a social networking server, said method comprising:
sending a full multimedia content residing on said venue server to a network node;
receiving an index associated with a multimedia content selected by an end user from said full multimedia content;
selecting said multimedia content that corresponds to said received index from said full multimedia content; and
sending said selected multimedia content or a version of said selected multimedia content to said social networking server to trigger uploading of said selected multimedia content or said version of said selected multimedia content on said social networking server on behalf of said end user.

69. The method according to claim 68, wherein
receiving said index comprises receiving said index and an identifier of said end user at said social networking server; and
sending said selected multimedia content comprises sending said selected multimedia content or said version of said selected multimedia content and said received identifier to said social networking server to trigger uploading of said selected multimedia content or said version of said selected multimedia content on said social networking server on behalf of said end user identified by said received identifier.

70. The method according to claim 68, wherein receiving said index comprises receiving said index and at least one of a processing command and a parameter defining a selected multimedia processing operation for said selected multimedia content, and wherein said method further comprises:
processing said selected multimedia content according to said multimedia processing operation defined by said received at least one of said processing command and said parameter to obtain a processed version of said selected multimedia content, wherein
sending said selected multimedia content comprises sending said processed version of said selected multimedia content to said social networking server to trigger uploading of said processed version of said selected multimedia content on said social networking server on behalf of said end user.

71. The method according to claim 68, wherein
receiving said index comprises receiving said index and text information entered by said end user on said communication device; and
sending said selected multimedia content comprises sending said selected multimedia content or said version of said selected multimedia content and said text information to said social networking server to trigger uploading of said selected multimedia content or said version of said selected multimedia content together with said text information on said social networking server on behalf of said end user.

72. The method according to claim 68, wherein
sending said full multimedia content comprises sending a low quality version of said full multimedia content to said network node, wherein said full multimedia content residing on said venue server is a high quality version of said full multimedia content; and
selecting said multimedia content comprises selecting a high quality version of a multimedia content from said high quality version of said full multimedia content that corresponds to said received index; and
sending said selected multimedia content comprises sending said high quality version of said selected multimedia content to said social networking server to trigger uploading of said high quality version of said selected multimedia content on said social networking server on behalf of said end user.

73. A method for a social networking server for uploading a multimedia content, said method comprising:
receiving an index associated with a multimedia content selected by an end user from a full multimedia content residing on a venue server;
sending said index to said venue server;
receiving said selected multimedia content or a version of said selected multimedia content from said venue server; and
uploading said selected multimedia content or said version of said selected multimedia content on behalf of said end user.

74. The method according to claim 73, wherein
receiving said index comprises receiving said index and an identifier of said end user at said social networking server; and
uploading said selected multimedia content comprises uploading said selected multimedia content or said version of said selected multimedia content on behalf of said end user identified by said identifier.

75. A communication device, comprising:
communication circuitry configured for communication with network nodes in a communication network; and
processing circuitry operatively associated with said communication circuitry and configured to:
send, to a network node, an index associated with a multimedia content selected from a full multimedia content broadcasted or multicasted from the same or another network node, to trigger uploading of said selected multimedia content or a version of said selected multimedia content on a social networking server on behalf of an end user of said communication device.

76. The communication device according to claim 75, wherein said processing circuitry is configured to:
receive said full multimedia content broadcasted or multicasted from said same or other network node;
generate said index associated with said multimedia content selected from said full multimedia content; and
send said index to said network node to trigger uploading of said selected multimedia content or said version of said selected multimedia content on said social networking server on behalf of said end user.

77. The communication device according to claim 75, wherein said processing circuitry is configured to send said index and an identifier of said end user at said social networking server to said network node, to trigger uploading of said selected multimedia content or said version of said selected multimedia content on said social networking server on behalf of said end user identified by said identifier.

78. The communication device according to claim 75, wherein said processing circuitry is configured to download or stream, using a broadcast or multicast transmission from said same or other network node, said full multimedia content to a social networking application running on said communication device.

79. The communication device according to claim 75, wherein said processing circuitry is configured to:
select a multimedia processing operation for said selected multimedia content; and
send said index and at least one of a processing command and a parameter defining said selected multimedia processing operation to said network node to trigger uploading of a processed version of said selected multimedia content processed according to said multimedia processing operation on said social networking server on behalf of said end user.

80. The communication device according to claim 75, wherein said processing circuitry is configured to send, to said network node, said index and text information entered by said end user on said communication device to trigger uploading of said selected multimedia content or said version of said selected multimedia content together with said text information on said social networking server on behalf of said end user.

81. The communication device according to claim 75, wherein said processing circuitry is configured to:
receive a low quality version of said full multimedia content broadcasted or multicasted from said same or other network node, wherein a high quality version of said full multimedia content is residing on a venue server; and
send an index associated with a low quality version of said selected multimedia content to said network node to trigger uploading of a high quality version of said selected multimedia content on said social networking server on behalf of said end user.

82. The communication device according to claim 75, further comprising:
a memory comprising instructions that, when executed by said processing circuitry, cause said communication device to:
receive said full multimedia content broadcasted or multicasted from said same or other network node;
generate said index associated with said multimedia content selected from said full multimedia content; and
send said index to said network node to trigger uploading of said selected multimedia content or said version of said selected multimedia content on said social networking server on behalf of said end user.

83. An arrangement configured for operation in association with one or more network nodes of a communication network, the arrangement comprising:
communication circuitry; and
processing circuitry operatively associated with said communication circuitry and configured to:
broadcast or multicast a full multimedia content received from a venue server housing said full multimedia content; and
send an index associated with a multimedia content selected by an end user from said full multimedia content, to trigger uploading of said selected multimedia content or a version of said selected multimedia content on a social networking server on behalf of said end user.

84. The arrangement according to claim 83, wherein said processing circuitry is configured to:
receive said full multimedia content from said venue server;
broadcast or multicast said full multimedia content to a communication device of said end user;
receive, from said communication device, said index associated with said multimedia content selected from said full multimedia content; and
send said received index to trigger uploading of said selected multimedia content or said version of said selected multimedia content on said social networking server on behalf of said end user.

85. The arrangement according to claim 83, wherein said processing circuitry is configured to send said received index to said venue server or to said social networking server to trigger uploading, by said venue server, of said selected multimedia content or said version of said selected multimedia content on said social networking server on behalf of said end user.

86. The arrangement according to claim 83, wherein said processing circuitry is configured to:
receive, from said communication device, said index and an identifier of said end user at said social networking server; and
send said received index and said received identifier to trigger uploading of said selected multimedia content or said version of said selected multimedia content on said social networking server on behalf of said end user identified by said received identifier.

87. The arrangement according to claim 83, wherein said processing circuitry is configured to:
receive, from said communication device, said index and at least one of a processing command and a parameter defining a selected multimedia processing operation for said selected multimedia content; and
send said received index and said at least one of said processing command and said parameter to trigger said venue server to upload a processed version of said selected multimedia content processed according to said multimedia processing operation on said social networking server on behalf of said end user.

88. The arrangement according to claim 83, wherein said processing circuitry is configured to:
receive, from said communication device, said index and text information entered by said end user on said communication device; and
send said received index and said text information to trigger uploading of said selected multimedia content or of said version of said selected multimedia content together with said text information on said social networking server on behalf of said end user.

89. The arrangement according to claim 83, wherein said processing circuitry is configured to:
broadcast or multicast a low quality version of said full multimedia content to said communication device, wherein said full multimedia content residing on said venue server is a high quality version of said full multimedia content; and
send a received index associated with a low quality version of said selected multimedia content to trigger said venue server to upload a high quality version of said selected multimedia content on said social networking server on behalf of said end user.

90. The arrangement according to claim 83, further comprising:
a memory comprising instructions that, when executed by said processing circuitry, cause said network node arrangement to:
receive said full multimedia content from said venue server;
broadcast or multicast said full multimedia content to said communication device;
receive, from said communication device, said index associated with said multimedia content selected from said full multimedia content; and
send said received index to trigger uploading of said selected multimedia content or said version of said selected multimedia content on said social networking server on behalf of said end user.

91. A venue server, comprising:
communication circuitry; and
processing circuitry operatively associated with said communication circuitry and configured to:
send, to a social networking server, a multimedia content selected based on a received index associated with a multimedia content selected by an end user from a full multimedia content residing on said venue server, to trigger uploading of said selected multimedia content or a version of said selected multimedia content on said social networking server on behalf of said end user.

92. The venue server according to claim 91, wherein said processing circuitry is configured to:
send said full multimedia content residing on said venue server to a network node;
receive said index associated with said multimedia content selected by said end user from said full multimedia content;
select a multimedia content that corresponds to said received index from said full multimedia content; and
send said selected multimedia content or said version of said selected multimedia content to said social networking server to trigger uploading of said selected multimedia content or said version of said selected multimedia content on said social networking server on behalf of said end user.

93. The venue server according to claim 91, wherein said processing circuitry is configured to receive said index from said network node or from said social networking server.

94. The venue server according to claim 91, wherein said processing circuitry is configured to:
receive said index and an identifier of said end user at said social networking server; and
send said selected multimedia content or said version of said selected multimedia content and said received identifier to said social networking server to trigger uploading of said selected multimedia content or said version of said selected multimedia content on said social networking server on behalf of said end user identified by said received identifier.

95. The venue server according to claim 91, wherein said processing circuitry is configured to receive said full multimedia content from at least one multimedia generating or capturing equipment.

96. The venue server according to claim 91, wherein said processing circuitry is configured to:
receive said index and at least one of a processing command and a parameter defining a selected multimedia processing operation for said selected multimedia content;
process said selected multimedia content according to said multimedia processing operation defined by said received at least one of said processing command and said parameter to obtain a processed version of said selected multimedia content; and
send said processed version of said selected multimedia content to said social networking server to trigger uploading of said processed version of said selected multimedia content on said social networking server on behalf of said end user.

97. The venue server according to claim 91, wherein said processing circuitry is configured to:
receive said index and text information entered by said end user on a communication device; and
send said selected multimedia content or said version of said selected multimedia content and said text information to said social networking server to trigger uploading of said selected multimedia content or said version of said selected multimedia content together with said text information on said social networking server on behalf of said end user.

98. The venue server according to any of the claim 91, wherein said processing circuitry is configured to:
send a low quality version of said full multimedia content to said network node, wherein said full multimedia content residing on said venue server is a high quality version of said full multimedia content; and
select a high quality version of a multimedia content from said high quality version of said full multimedia content that corresponds to said received index; and
send said high quality version of said selected multimedia content to said social networking server to trigger uploading of said high quality version of said selected multimedia content on said social networking server on behalf of said end user.

99. The venue server according to claim 91, further comprising:
a memory comprising instructions that, when executed by said processing circuitry, cause said venue server to:
send said full multimedia content residing on said venue server to said network node;
receive said index associated with said multimedia content selected by said end user from said full multimedia content;
select said multimedia content that corresponds to said received index from said full multimedia content; and
send said selected multimedia content or said version of said selected multimedia content to said social networking server to trigger uploading of said selected multimedia content or said version of said selected multimedia content on said social networking server on behalf of said end user.

100. A social networking server, comprising:
communication circuitry; and
processing circuitry operatively associated with said communication circuitry and configured to:
send, to a venue server, an index associated with a multimedia content selected by an end user from a full multimedia content residing on said venue server; and
upload, on behalf of said end user, said selected multimedia content or a version of said selected multimedia content received from said venue server.

101. The social networking server according to claim 100, wherein the processing circuitry is configured to:
receive said index associated with said multimedia content selected by said end user from said full multimedia content residing on said venue server;
send said index to said venue server;
receive said selected multimedia content or said version of said selected multimedia content from said venue server; and
upload said selected multimedia content or said version of said selected multimedia content on behalf of said end user.

102. The social networking server according to claim 100, wherein said processing circuitry is configured to:
receive said index and an identifier of said end user at said social networking server; and
upload said selected multimedia content or said version of said selected multimedia content on behalf of said end user identified by said identifier.

103. The social networking server according to claim 100, further comprising:
a memory comprising instructions that, when executed by said processing circuitry, cause said social networking server to:
receive said index;
send said index to said venue server;
receive said selected multimedia content or said version of said selected multimedia content from said venue server; and
upload said selected multimedia content or said version of said selected multimedia content on behalf of said end user.

104. A non-transitory computer readable storage medium storing a computer program comprising instructions, which when executed by a processor of a communication device of an end user, cause said processor to provide for transmission, to a network node, an index associated with a multimedia content selected from a full multimedia content broadcasted or multicasted from the same or another network node, to trigger uploading of said selected multimedia content or a version of said selected multimedia content on a social networking server on behalf of the end user.

105. A non-transitory computer readable storage medium storing a computer program comprising instructions, which when executed by a processor comprised in an arrangement associated with one or more network nodes of a communication network, cause said processor to:
output for broadcast or multicast of a full multimedia content received from a venue server housing said full multimedia content; and
send an index associated with a multimedia content selected by an end user of a communication device connected to the communication network, the selected multimedia content being selected from said full multimedia content, and said index being sent to trigger uploading of said selected multimedia content or a version of said selected multimedia content on a social networking server on behalf of said end user.

106. A non-transitory computer readable storage medium storing a computer program comprising instructions, which when executed by a processor of a venue server, cause said processor to provide for transmission, to a social networking server, of a multimedia content selected based on a received index associated with a multimedia content selected by an end user from a full multimedia content residing on said venue server to trigger uploading of said selected multimedia content or a version of said selected multimedia content on said social networking server on behalf of said end user.

107. A non-transitory computer readable storage medium storing a computer program comprising instructions, which when executed by a processor of a social networking server, cause said processor to:
provide for transmission, to a venue server, of an index associated with a multimedia content selected by an end user from a full multimedia content residing on said venue server; and
upload, on behalf of said end user, said selected multimedia content or a version of said selected multimedia content received from said venue server.
